(19) United States
(12) Patent Application Publication
(10) Pub. No.: US 2015/0132536 A1
(43) Pub. Date: May 14, 2015

(54) High Color Rendering Index and High Thermal Characteristics of Red Nitride Phosphors

(71) Applicant: Chung-Shan Institute of Science and Technology, Longtan/Taoyuan (TW)

(72) Inventors: Yin-Chih Lin, Hsinchu (TW); Shin Mou Wu, Tainan (TW); Hao-En Hung, Taipei (TW); Yi-Ting Tsai, New Taipei City (TW); Chun-Che Lin, Dongshan/Yilan (TW); Mu-Huai Fang, Longtan/Taoyuan (TW); Ru-Shi Liu, New Taipei City (TW); Li Chun Wang, Longtan/Taoyuan (TW); Chi Hsing Hsieh, Taipei (TW)

(21) Appl. No.: 14/074,961

(22) Filed: Nov. 8, 2013

(51) Int. Cl. C09K 11/77

(52) U.S. Cl. CPC C09K 11/7792; C09K 11/7728
USPC 428/141; 252/301.4 F

(57) ABSTRACT

The high color rendering index (CRI) and high thermal properties of the red nitride phosphor are proposed in the invention. The phosphor would keep the original crystal phase and reduce the change of crystal volume by replacing different atoms. In addition, the red nitride phosphor can be excited by an incident light with wavelength ranging from 370 nm to 470 nm, and that shows the red phosphor of the present invention can be applied in white light emitting diodes. Moreover, the red nitride phosphor proposed by the present invention includes the potential application in main peak modulation and FWHM adjustment, and would be helpful to improve the thermal stability problem of white light emitting diodes.

### BACKGROUND OF THE INVENTION

1. Field of the Invention

The present invention is concerned to high color rendering index and better thermal property nitride phosphors.

2. Description of the Prior Art

Recently, White Light-Emitting diodes (WLEDs) gradually becomes a new industry in next generation, due to the advantages of small volume, small thermal radiation, long life time, low power consumption and it can solve the problems that traditional incandescent bulbs cannot overcome. Nowadays, worldwide people paying more and more attention on energy saving, carbon reduction and environment protection reveals the developing potential of WLEDs in the new generation lighting market.

According to experts' assessments, at least a power plants' generating electricity can be saved if all the using incandescent bulbs are replaced by WLEDs. For example, in Taiwan, 11 billion kWh of electricity, equal to one year electricity generated by Nuclear Power Plant, could be saved if a quarter of incandescent bulbs and fluorescent lamps are replaced by WLEDs.

Last decade, colored light emitting diodes are generally used in lighting, monitors and entertainments. Among these industries, the electronic monitoring is the future optoelectronic applications.

Nowadays, main international companies develop the LEDs with RGB high color rendering index. In order to compensate the red spectrum that YAG phosphors are lack of, adding red phosphors into the white light LED becomes a new issue. For example, the patent U.S. Pat. No. 6,649,946 of a German company, Osram, announced that nitride, MₓSi_{y}N_{z}: Eu, wherein z=23x+43y, and the “M”=Ca, Sr, and Ba, can be used as a red phosphor in WLED. In 1995, Schlieper et al. synthesized M₂Si₅N₈ (M=Sr and Ba) and studied the crystal structure of these compounds. (T. Schlieper, W. Milius and W. Schnick, Z. anorg. allg. Chem. 621, 1995, 1380-1384) Their studies shows the space group of Ca₂Si₅N₈ Sr₂Si₅N₈ and Ba₂Si₅N₈ are Cc, Pmn21, and Pmn21, respectively. Now, the investigations of the red phosphor are focused on the improvement of the color rendering index and the thermal characteristic.

To the best of our knowledge, there is not any investigation considering that the color rendering index and the thermal characteristic of M₂Si₅N₈:Eu can be improved by doping two alkaline earth metals in main structure. The present invention shows that a new phosphor with a formula Sr_{2-x-y}(Ca_{0.55}Ba_{0.45})Si₅N₈: Eu²⁺_{y} (0<x<2; 0<y<2; 0<x+y<2) has high color rendering index and the great thermal characteristic.

### SUMMARY OF THE INVENTION

The primary objective of the present invention is a red nitride phosphor having high color rendering index and thermal properties. This red nitride phosphor is synthesized by fully mixing M₃N₂, Si₃N₄ and EuN and sintering under 0.5 MPa and 1600° C. Moreover, the chemical formula of the red nitride phosphor is Sr_{2-x-y}(Ca_{0.55}Ba_{0.45})xSi₅N₈: Eu²⁺_{y} (0<x<2, 0<y<2, 0<x+y<2). The practice of the present invention is using Sr_{1.98}Si₅N₈: Eu²⁺_{0.02} as a main structure and replacing the Sr in main structure by (Ba, Ca) of particular ratio. Thus, the variation in volume of the crystal, resulting from the different size between substituent atoms and original atoms, can be reduced. Besides, the photoluminescence (PL) spectra show the red phosphor can be excited by the radiation of wavelength ranging from 370 to 470 nm. This feature indicates that the red phosphor can be applied in blue light excited WLEDs. Moreover, red-shift from 613 nm to 633 nm and the broadening of full width at half maximum (FWHM) from 84 nm to 115 nm reveal that emission color of this phosphor can be tuned. Therefore, the color rendering index of WLED can be improved. Additionally, temperature dependent PL spectra show the thermal characteristic of the present invention can be increased (better thermal-resisting characteristic) by increasing the substitution of (Ba, Ca), especially when x=1.5.

A mixed phosphor can be obtained by mixing the red nitride phosphor with a yellow phosphor with(?) the chemical formula of YAG(Y₃Al₅₁₂:Ce³⁺). The mixed phosphor can be excited by blue LED chip and generate the white light with high color rendering index of 83. In order to achieve the primary objective of the present invention, the inventors of the present invention propose a red nitride phosphor with high color rendering index and thermal properties. The chemical formula is Sr_{2-x-y}(Ca_{0.55}Ba_{0.45})Si₅N₈:Eu²⁺_{y}, wherein x and y are both greater than 0 and smaller than 2, and the value of (x+y) being greater than 0 and smaller than 2.

Moreover, in the aforesaid red nitride phosphor with high color rendering index and thermal properties, Sr_{2-x-y}(Ca_{0.55}Ba_{0.45})ₓSi₅N₈:Eu²⁺_{y} is made by mixing M₃N₂, Si₃N₄ and EuN as precursor and sintering for 2 hours under 0.5 MPa and 1600° C., wherein “M” is selected from the group consisting of Ca, Sr and Ba.

In the aforesaid chemical formula of Sr_{2-x-y}(Ca_{0.55}Ba_{0.45})Si₅N₈: Eu²⁺_{y}, x and y are both greater than 0 and smaller than 2, and the value of (x+y) is greater than 0 and smaller than 2. Therefore, a mixed phosphor can be obtained by mixing the red nitride phosphor with a yellow phosphor having the chemical formula of YAG(Y₃Al₅O₁₂:Ce³⁺), and the Ra of a mixed light emitted by the mixed phosphor can reach to 87 when making x and y in the Sr_{2-x-y}(Ca_{0.55}Ba_{0.45})ₓSi₅N₈: Eu²⁺_{y} be 1.5 and 0.02, respectively. Moreover, the red nitride phosphor would show a best thermal properties when making x and y in the Sr_{2-x-y}(Ca_{0.55}Ba_{0.45})ₓSi₅N₈: Eu²⁺_{y} be 1.5 and 0.02, respectively.

### BRIEF DESCRIPTION OF THE DRAWINGS

The invention as well as a preferred mode of uses and advantages thereof will be best understood by referring to the following detailed description of an illustrative embodiment in conjunction with the accompanying drawings, wherein:

FIG. 1 is XRD spectrum of the red nitride phosphor of Sr_{1.98-x}(Ca_{0.55}Ba_{0.45})ₓSi₅N₈;Eu²⁺_{0.02} (0≦x≦1.98) according to the present invention;

FIG. 2 is the excitation spectrum of the red nitride phosphor of Sr_{1.98-x}(Ca_{0.55}Ba_{0.45})ₓSi₅N₈: Eu²⁺_{0.02} (0≦x≦1.98) according to the present invention;

FIG. 3 is the normalized emission spectrum of the red nitride phosphor according to the present invention;

FIG. 4 is the temperature-depend emission spectrum of the red nitride phosphor according to the present invention.

### DESCRIPTION OF EMBODIMENTS

In the present invention, M₃N₂, Si₃N₄ and EuN are taken as precursor for constituting a red nitride phosphor, wherein the “M” in M₃N₂ can be calcium (Ca), strontium (Sr) or barium (Ba). The M₃N₂, Si₃N₄ and EuN are sintered for 2 hours under 0.5 MPa and 1600° C. , therefore the red nitride phosphor with chemical formula of Sr_{2-x-y}(Ca_{0.55}Ba_{0.45})Si₅N₈:Eu²⁺_{y} is obtained. In the aforesaid chemical formula, both x and y are greater than 0 and smaller than 2; moreover, the value of (x+y) is also greater than 0 and smaller than 2. Preferably, Sr_{1.98}Si₅N₈: Eu²⁺_{0.02} (i.e., y=0.02) is taken as a primary phosphor, and then the red nitride phosphor of Sr_{1.98-x}(Ca_{0.55}Ba_{0.45})ₓSi₅N₈:Eu2+_{0.02} (0≦x≦1.98) is obtained after replacing partial of Sr in the red nitride phosphor by Ca and Ba with a specific ratio. By this way, it is able to reduce the variation of crystal volume change after the partial Sr is replaced by Ca and Ba, so as to keep the original crystal phase of the red nitride phosphor.

For improving the practicability of the present invention, the red nitride phosphor of Sr_{1,98-x}(Ca_{0.55}Ba_{0.45})ₓSi₅N₈:Eu²⁺_{0.02} (0≦x≦1.98; 0.02≦x+y≦2) is made of M₃N₂, Si₃N₄ and EuN after being sintered for 2 hours under 0.5 Mpa and 1600° C.

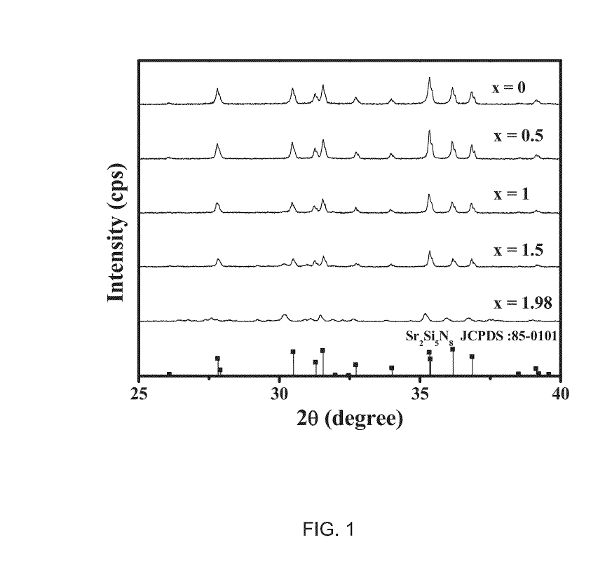

With reference to FIG. 1, which illustrates the XRD spectrum of the red nitride phosphor of Sr_{1.98-x}(Ca_{0.55}Ba_{0.45})ₓSi₅N₈:Eu²⁺_{0.002} (0≦x≦1.98). As shown in FIG. 1, obviously, comparing to the pure phase red nitride phosphor of Sr_{1.98}Si₅N₈:Eu²⁺_{0.02} (x=0; y=0.02), the red nitride phosphor of Sr_{1.98-x}(Ca_{0.55}Ba_{0.45})ₓSi₅N₈: Eu²⁺_{0.02} still reveal pure phase structure when the x is smaller than 1.5. However, when the x is equal to 1.98, the crystal phase of the red nitride phosphor of Sr_{1.98-x}(Ca_{0.55}Ba_{0.45})ₓSi₅N₈: Eu²⁺_{0.02} start to change.

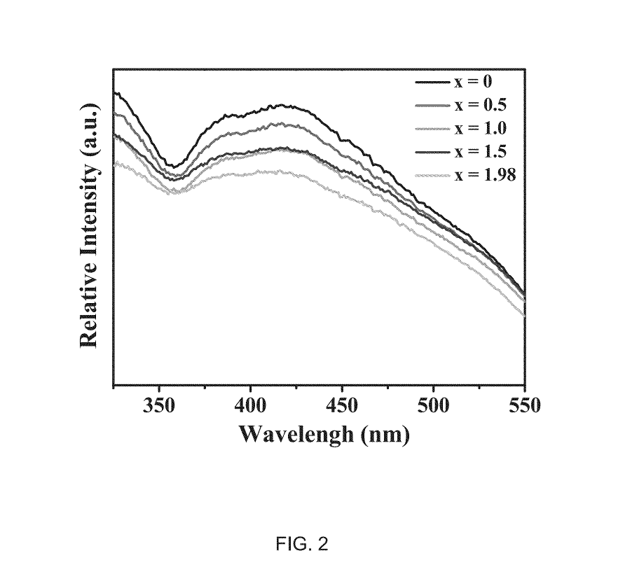

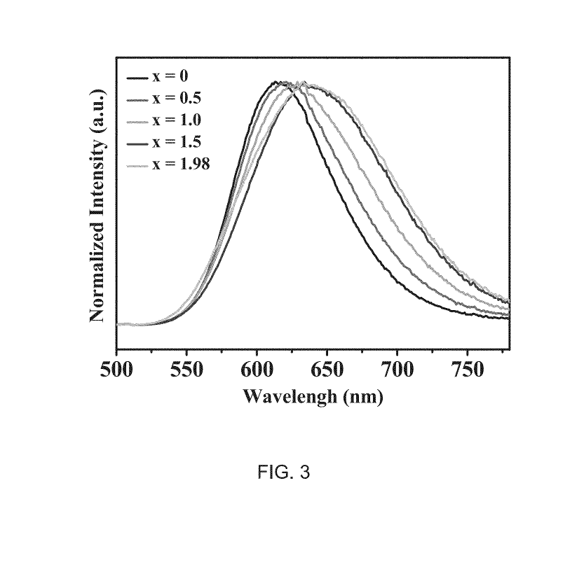

According to the excitation spectrum of Sr_{1.98-x}(Ca_{0.55}Ba_{0.45})ₓSi₅N₈:Eu²⁺_{0.02} (0≦x≦1.98) showing in FIG. 2 the red nitride phosphor can be excited by an incident light with the wavelength ranging from 370 nm to 470 nm. As a result, Sr_{1.98-x}(Ca_{0.55}Ba_{0.45})ₓSi₅N₈:Eu²⁺_{0.02} (0≦x≦1.98) red phosphor can be applied in white light emitting diodes. According to the normalized emission excitation spectrum of Sr_{1.98-x}(Ca_{0.55}Ba_{0.45})ₓSi₅N₈:Eu²⁺_{0.02} (0≦x≦1.98) showing in FIG. 3, the main emission peak shifts from 613 nm to 633 nm when x is changed from 0 to 1.98. Moreover, when the x is changed from 0 to 1.98, the full width at half maximum (FWHM) of the emitting spectrum of the Sr_{1.98-x}(Ca_{0.55}Ba_{0.45})ₓSi₅^{N}₈:Eu²⁺_{0.02} (0≦x≦1.98) is increased from 84 nm to 115 nm, which shows the red nitride phosphor of Sr_{1.98-x}(Ca_{0.55}Ba_{0.45})ₓSi₅N₈:Eu²⁺_{0.02} (0≦x≦1.98) proposed by the present invention includes the potential application in main peak modulation and FWHM adjustment.

Besides, a mixed phosphor can be obtained by mixing the red nitride phosphor with a yellow phosphor having the chemical formula of Y₃Al₅O₁₂:Ce³⁺(YAG). The color rendering index, Ra, is changed from 77 to 87 when x is changed from 0 to 1.5 which shows that the red nitride phosphor of the present invention is helpful to raise the color rendering index of white light emitting diodes.

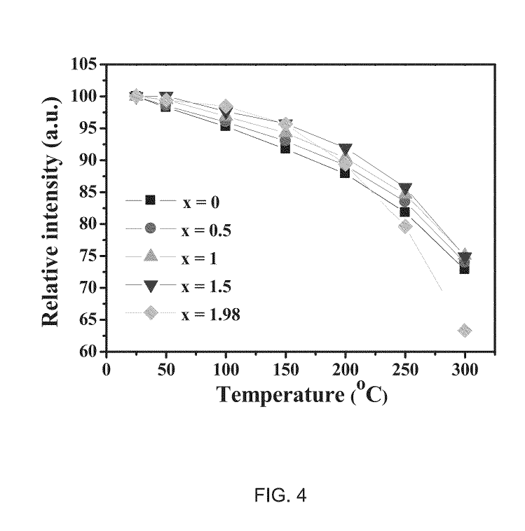

The temperature-depend emission spectrum is shown in FIG. 4. When x is changed from 0 to 1.98, the thermal stability of the Sr_{1.98-x}(Ca_{0.55}Ba_{0.45})ₓSi₅N₈:Eu²⁺_{0.02} (0≦x≦1.98) are gradually enhanced, showing that the red nitride phosphor we proposed would be helpful to improve the thermal properties of white light emitting diodes.

We claim:

1. A red nitride phosphor with high color rendering index and thermal properties, being represented by following chemical formula: Sr_{2-x-y}(Ca_{0.55}Ba_{0.45})Si₅N₈: Eu²⁺_{y}, wherein x and y are both greater than 0 and smaller than 2, and the value of (x+y) being greater than 0 and smaller than 2.

2. A process according to claim 1, the red nitride phosphor with high color rendering index and thermal properties, wherein the Sr_{2-x-y}(Ca_{0.55}Ba_{0.45})ₓSi₅N₈: Eu²⁺_{y} is synthesized by M₃N₂, Si₃N₄ and EuN. The “M” in the M₃N₂ is selected from the group consisting of: Ca, Sr and Ba.

3. A process according to claim 1, the red nitride phosphor with high color rendering index and thermal properties, wherein the value of x is greater than 0 and smaller than 1.98.

4. A process according to claim 1, the red nitride phosphor with high color rendering index and thermal properties, wherein the Sr_{2-x-y}(Ca_{0.55}Ba_{0.45})Si₅N₈: Eu²⁺_{y} can be excited by the light with the wavelength from 370 nm to 470 nm.

5. A process according to claim 1, the red nitride phosphor with high color rendering index and thermal properties, wherein the wavelength of the incident light is ranged from 613 nm to 633 nm.

6. A process according to claim 1, the red nitride phosphor with high color rendering index and thermal properties , wherein a mixed phosphor can be obtained by mixing the red nitride phosphor with a yellow phosphor of the chemical formula of Y₃Al₅O₁₂:Ce³ (YAG), and the Ra of a mixed light emitted by the mixed phosphor can reach to 87 when making x and y in the Sr_{2-x-y}(Ca_{0.55}Ba_{0.45})ₓSi₅N₈: Eu²⁺₃, be 1.5 and 0.02, respectively.

7. A process according to claim 1, the red nitride phosphor with high color rendering index and thermal properties, wherein the red nitride phosphor would show the best thermal properties when making x and y in the Sr_{2-x-y}(Ca_{0.55}Ba_{0.45})ₓSi₅N₈: Eu²⁺_{y} be 1.5 and 0.02, respectively.

8. A process according to claim 1, the red nitride phosphor with high color rendering index and thermal properties, wherein the red nitride phosphor can be composed under normal pressure or high pressure.
